(19) United States
(12) Patent Application Publication
(10) Pub. No.: US 2025/0164641 A1
(43) Pub. Date: May 22, 2025

(54) LASER SYSTEM AND LASER MEASUREMENT METHOD

(71) Applicant: Rayz Technologies Co. Ltd., Beijing (CN)

(72) Inventors: Ruxin CHEN, Beijing (CN); Detao DU, Beijing (CN)

(21) Appl. No.: 18/834,599

(22) PCT Filed: Jan. 30, 2023
(86) PCT No.: PCT/CN2023/073760

§ 371 Date: Jul. 30, 2024

(30) Foreign Application Priority Data
Jan. 30, 2022 (CN) 202210113638.0

(51) Int. Cl. G01S 17/42; G01S 7/484; G01S 7/4863; G01S 17/894

(52) U.S. Cl. CPC G01S 17/42; G01S 7/484; G01S 7/4863; G01S 17/894

(57) ABSTRACT

A laser system and a laser measurement method are provided. The laser system may include: a light emitting assembly, configured to sequentially emit multiple groups of emitted light within a current frame scanning duration; and a receiving end assembly, configured to convert at least one group of reflected light into an output signal; where within a scanning duration, a position of a receiving field of view of the receiving end assembly in the target scene changes and/or a shape of the receiving field of view changes; from an emission start moment, an emitting field of view of the light emitting assembly is located in the current receiving field of view within a preset receiving duration, and an area of the receiving field of view is greater than or equal to twice an area of the emitting field of view.

### CROSS-REFERENCE TO RELATED APPLICATIONS

This application is a national stage of International Application No. PCT/CN2023/073760, filed on Jan. 30, 2023, which claims the priority and benefit of Chinese Patent Application No. 202210113638.0, filed on Jan. 30, 2022 and submitted in the China National Intellectual Property Administration (CNIPA). Both of the aforementioned applications are hereby incorporated by reference in their entireties.

### TECHNICAL FIELD

The present disclosure relates to the field of radar technology and, more specifically, to a laser system and a laser measurement method.

### BACKGROUND

Radar is an electronic device that uses electromagnetic waves to detect target objects. Radar emits electromagnetic waves to target objects and receives their echoes, and after processing, it can obtain information such as distance, orientation and height of the target objects to the emission point where the electromagnetic waves are emitted.

A radar that uses a laser as work light beam is called lidar. In the related technology, a receiving field of view and an emitting field of view are basically of the same size, and in order to improve resolution along a certain direction, a lidar has multiple emitting fields of view along the direction, so that it is required to correspondingly match receiving fields of view of the same number as the emitting fields of view, that is for each emitting field of view, the lidar has only one receiving field of view corresponding to the emitting field of view within a preset duration. To achieve accurate and fast synchronous match between the emitting field of view and the receiving field of view, the lidar needs to set up a complex control system to control a light scanner to accurately deflect emitted light and reflected light, which not only significantly increases the complexity of the entire lidar, but also increases costs. Moreover, the higher the resolution is, the higher the complexity and costs of the lidar are.

### SUMMARY

The present disclosure relates to a laser system and a laser measurement method.

According to an embodiment of the present disclosure, the laser system may include:
a light emitting assembly, configured to generate an emitting signal and sequentially emit multiple groups of emitted light within a current frame scanning duration according to the emitting signal; where, the emitting signal includes time information indicating an emission start moment of each group of the emitted light; and
a receiving end assembly, configured to convert at least one group of reflected light formed by reflecting the emitted light at at least one target object in a target scene into an output signal; where a type of the output signal is electrical signal;
where within the current frame scanning duration, a position of a receiving field of view of the receiving end assembly in the target scene changes according to a first designated rule and/or a shape of the receiving field of view changes according to a second designated rule; from an emission start moment at which corresponding emitted light is emitted, an emitting field of view of the light emitting assembly is located in the current receiving field of view within a preset receiving duration, and an area of the receiving field of view is greater than or equal to twice an area of the emitting field of view; where the first designated rule includes a change along a designated direction; the emitting field of view is a projection area of each group of the emitted light in the target scene, and the receiving field of view is an area in the target scene corresponding to all light beams that can be received by the receiving end assembly within the preset receiving duration.

According to an embodiment of the present disclosure, the laser measurement method may include:
generating an emitting signal and sequentially emitting multiple groups of emitted light within a current frame scanning duration according to the emitting signal;
converting at least one group of reflected light formed by reflecting the emitted light at at least one target object in a target scene into an output signal; where, a type of the output signal is electrical signal; and
determining at least one of a distance to the target object, a reflectivity of the target object, or a contour of the target object, based on the emitting signal and/or the output signal;
where within the current frame scanning duration, a position of a receiving field of view in the target scene changes according to a first designated rule and/or a shape of the receiving field of view changes according to a second designated rule; from an emission start moment at which corresponding emitted light is emitted, an emitting field of view is located in the current receiving field of view within a preset receiving duration, and an area of the receiving field of view is greater than or equal to twice an area of the emitting field of view; where the first designated rule includes a change along a designated direction; the emitting field of view is a projection area of each group of the emitted light in the target scene, and the receiving field of view is an area in the target scene corresponding to all light beams that can be converted into the output signal within the preset receiving duration.

In the present disclosure, since the emitting field of view of the light emitting assembly is located in the current receiving field of view of the receiving end assembly within the preset receiving duration from the emission start moment at which the corresponding emitted light is emitted, and the area of the receiving field of view is greater than or equal to twice the area of the emitting field of view, there is no need to accurately and synchronously match the emitting field of view with the receiving field of view by using a light scanning assembly at a high speed, thus the complexity and costs of the whole system can be reduced under the condition of ensuring resolution.

Those skilled in the art will understand that the above summary content is only illustrative and is not intended to be limited in any way. In addition to the explanatory aspects, implementation methods, and features mentioned above, other aspects, implementation methods, and features will become apparent by referring to the accompanying drawings and the following detailed description.

### BRIEF DESCRIPTION OF THE DRAWINGS

Other features, objectives and advantages of the present disclosure will become more apparent by reading detailed descriptions of non-limiting embodiments made with reference to the following accompanying drawings:

FIG. 1 is a schematic diagram of a receiving field of view and an emitting field of view of a laser system according to an embodiment of the present disclosure;

FIG. 2 is a block diagram of the laser system according to an embodiment of the present disclosure;

FIG. 3 is a block diagram of the laser system according to another embodiment of the present disclosure;

FIG. 4 is a schematic diagram of an operation principle of a receiving end assembly according to an embodiment of the present disclosure;

FIG. 5 is a schematic diagram of the operation principle of the receiving end assembly according to another embodiment of the present disclosure;

FIG. 6 is a schematic diagram of a partial operation principle of the laser system according to an embodiment of the present disclosure;

FIG. 7 is a schematic diagram of the receiving field of view and the emitting field of view of the laser system according to another embodiment of the present disclosure;

FIG. 8 is a schematic diagram of the receiving field of view and the emitting field of view of the laser system according to yet another embodiment of the present disclosure;

FIG. 9 is a schematic structural diagram of a light scanning assembly according to an embodiment of the present disclosure;

FIG. 10 is a schematic structural diagram of the light scanning assembly according to another embodiment of the present disclosure;

FIG. 11 is a schematic diagram of an operation principle of determining a superpixel of the receiving field of view by the laser system according to an embodiment of the present disclosure; and

FIG. 12 is a flowchart of a laser measurement method according to an embodiment of the present disclosure.

### DETAILED DESCRIPTION OF EMBODIMENTS

In order to better understand the present disclosure, more detailed explanations of various aspects of the present disclosure will be provided with reference to the accompanying drawings. It should be understood that these detailed explanations are only descriptions of exemplary embodiments disclosed herein, and are not intended to limit the scope of this disclosure in any way. For ease of description, the accompanying drawings only show parts related to the present invention rather than the entire structure.

Unless otherwise limited, all terms used in the disclosure (including engineering and technological terms) have the same meanings as those commonly understood by those skilled in the art to which this disclosure belongs. It should also be understood that, unless explicitly stated in this disclosure, terms such as those limited in commonly used dictionaries should be interpreted as having meanings consistent with their meanings in the context of the relevant technology, and should not be interpreted in idealized or overly formal terms.

It should be noted that, without conflict, the embodiments and features in the embodiments disclosed herein can be combined with each other. In addition, unless explicitly limited or contradictory to the context, the specific steps included in the methods disclosed herein need not be limited to the order recorded, but can be executed in any order or in parallel. Hereafter, the disclosure is described in detail with reference to the accompanying drawings and in combination with the embodiments.

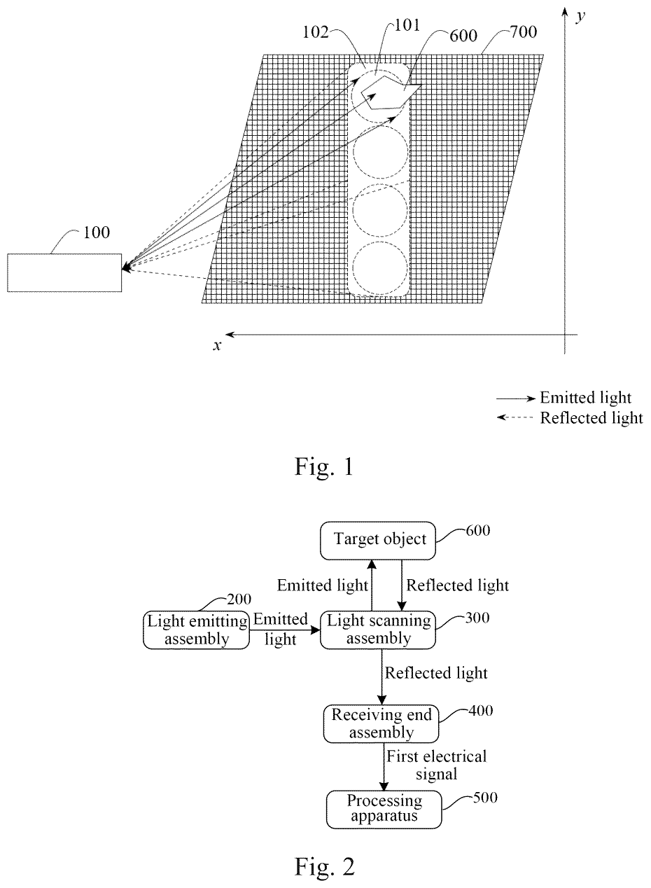

As shown in FIG. 1 and FIG. 6, an embodiment of the present disclosure provides a laser system 100, which includes a light emitting assembly 200 and a receiving end assembly 400; where the light emitting assembly 200 is configured to generate an emitting signal and sequentially emit multiple groups of emitted light within a current frame scanning duration according to the emitting signal; the emitting signal includes time information indicating an emission start moment of each group of the emitted light; where the receiving end assembly 400 is configured to convert at least one group of reflected light formed by reflecting the emitted light at at least one target object 600 in a target scene 700 into an output signal, and a type of the output signal is an electrical signal; where within the current frame scanning duration, a position of a receiving field of view 102 of the receiving end assembly 400 in the target scene 700 changes according to a first designated rule and/or a shape of the receiving field of view 102 in the target scene 700 changes according to a second designated rule; and from an emission start moment at which corresponding emitted light is emitted, an emitting field of view 101 of the light emitting assembly 200 is located in the current receiving field of view 102 within a preset receiving duration, and an area of the receiving field of view 102 is greater than or equal to twice an area of the emitting field of view 101. Here, the first designated rule includes changing along a designated direction; and the emitting field of view 101 is a projection area of each group of the emitted light in the target scene 700, and the receiving field of view 102 is an area in the target scene 700 corresponding to all light beams that can be received by the receiving end assembly 400 within the preset receiving duration.

In an embodiment of the present disclosure, since the emitting field of view 101 of the light emitting assembly 200 is located in the current receiving field of view 102 of the receiving end assembly 400 within the preset receiving duration from the emission start moment at which the corresponding emitted light is emitted, and the area of the receiving field of view 102 is greater than or equal to twice the area of the emitting field of view 101, there is no need to use a light scanning assembly 300 to perform accurate and fast synchronous match between the emitting field of view 101 and the receiving field of view 102, thus the complexity and costs of the whole system can be reduced under the condition of ensuring resolution.

It should be noted that, “a position of a receiving field of view 102 in the target scene 700 changes according to a first designated rule” generally refers to the position of the receiving field of view 102 in the target scene 700 changes once each time the light emitting assembly 200 sequentially emits multiple groups of emitted light. For example, if the emitting fields of view 101 corresponding to the multiple groups of emitted light are arranged in a shape of a rectangular dot array within the current frame scanning duration, then the receiving field of view 102 moves once along a width direction of the rectangular dot array at an interval of a certain duration. Similarly, “a shape of the receiving field of view 102 in the target scene 700 changes according to a second designated rule” generally refers to the shape of the receiving field of view 102 in the target scene 700 changes once each time the light emitting assembly 200 sequentially emits multiple groups of emitted light. For example, if the emitting fields of view 101 corresponding to the multiple groups of emitted light are arranged in a shape of a ring of dots within the current frame scanning duration, then the receiving field of view 102 may be a ring-shaped area, and a width of the receiving field of view 102 is increased at an interval of a certain duration.

Considering that the receiving field of view 102 is larger than the emitting field of view 101, received background noise increases consequently, therefore, in order to properly reduce the noise to balance the noise, the costs, and the resolution, as shown in FIG. 1, the receiving field of view 102 includes at least one bar-shaped continuous area, the emitting fields of view 102 corresponding to the multiple groups of emitted light within the current frame scanning duration are arranged in a dot array, a length direction of the dot array adapts to a length direction of the receiving field of view 102, and a width direction of the dot array is parallel to a designated direction. It should be noted that “a length direction of the dot array adapts to a length direction of the receiving field of view 102” generally refers to that the length direction of the dot array corresponds to the length direction of the receiving field of view 102. For example, if the reflected light reflected by the target object 600 is not deflected by the light scanning assembly 300, then a light receiving assembly 410 does not deflect the reflected light, that is, the light receiving assembly 410 does not include a deflector lens, such as a 45° reflector, then the length direction of the dot array is parallel to the length direction of the receiving field of view 102. If the reflected light reflected by the target object 600 is deflected by the light scanning assembly 300 or the light receiving assembly 410, for example, by 45°, then the length direction of the dot array is no longer parallel to the length direction of the receiving field of view 102, but is parallel to a length direction of the receiving field of view 102 after deflecting the receiving field of view by 45°, i.e., in this regard, an angle between the length direction of the dot array and the length direction of the receiving field of view 102 is greater than zero.

In the case where the receiving field of view 102 is a whole continuous bar-shaped area: since the area of the receiving field of view 102 corresponding to each group of emitted light is greater than or equal to twice the area of the emitting field of view 101, i.e., the area of the receiving field of view 102 is much larger than the area of the emitting field of view 101, an emitting angle of the emitted light as well as a direction in which the reflected light is emitted to the receiving end assembly 400 do not need to be accurately controlled, that is, both the emitting field of view 101 and the receiving field of view 102 do not need to be accurately controlled, as long as the reflected light formed by reflecting each group of emitted light at the target object 600 can be emitted from any position of the current receiving field of view 102, and can be received by the receiving end assembly 400. Thus, the laser system in an embodiment of the present disclosure does not need to accurately and synchronously match the emitting field of view 101 with the receiving field of view 102 by accurately deflecting the emitted light and the reflected light by using the light scanning assembly 300. For example, as shown in FIG. 1, the number of groups of emitted light emitted from the light emitting assembly 200 within the current frame scanning duration is greater than four. Taking the first four groups of emitted light as an example, the position of the receiving field of view 102 of the receiving end assembly 400 in the target scene 700 does not change within a designated duration, i.e., from the emission start moment at which the first group of emitted light is emitted to an end of a preset receiving duration after the fourth group of emitted light is emitted, that is, the emitting fields of view 101 corresponding to the four groups of emitted light sequentially emitted by the light emitting assembly 200 all correspond to a given receiving field of view 102, and the position of the receiving field of view 102 changes along the designated direction at an interval of the above designated duration. Assuming that the area defined by each dashed circle in the target scene 700 in FIG. 1 is an emitting field of view 101, the area defined by the dashed rectangular box in the target scene 700 in FIG. 1 is the area in the target scene 700 corresponding to all light beams that can be received by the receiving end assembly 400, i.e., the current receiving field of view 102. Then, for each group of emitted light, the emitting field of view 101 may be the area defined by any of the dashed circles in FIG. 1, that is, the emitting angle of the emitted light does not need to be accurately controlled, and the reflected light of the emitted light projected into the area defined by any of the aforementioned dashed circles can be received by the receiving end assembly 400. It can be seen that in an embodiment of the present disclosure, both the emitting field of view 101 and the receiving field of view 102 need not to be accurately controlled.

In the case where the receiving field of view 102 includes multiple bar-shaped continuous areas: since from the emission start moment at which the corresponding emitted light is emitted, the emitting field of view 101 of the light emitting assembly 200 is located in the current receiving field of view 102 within the preset receiving duration, and the length direction of the dot array is adapted to the length direction of the receiving field of view, the continuous areas of the receiving field of view 102 correspond one-to-one with the emitting fields of view 101 of the light emitting assembly 200, that is, for any group of the emitted light, the multiple bar-shaped continuous areas of the receiving field of view 102 are set simultaneously within the preset receiving duration from the emission start moment at which the emitted light is emitted. Thus, as long as each group of the emitted light is emitted along a set direction, the reflected light formed by reflecting the emitted light at the target object 600 can definitely be emitted from the corresponding continuous areas of the receiving field of view 102, and thus received by the receiving end assembly 400. Therefore, the laser system in an embodiment of the present disclosure does not need to accurately perform synchronous match between the emitting field of view 101 and the receiving field of view 102 by accurately deflecting the reflected light from the target object 600 by using the light scanning assembly 300.

In addition, it should also be noted that the “bar-shaped continuous area” generally refers to an area with an aspect ratio greater than 1. The continuous area may be either a polygonal area, such as a rectangular area, or a curved area, such as an S-shaped area, or other irregularly shaped area, such as a special-shaped area. Here, a ratio of a maximal width to a total length of at least one continuous area is smaller than a first ratio threshold, and the first ratio threshold is not greater than 0.5, e.g., the first ratio threshold may be, but is not limited to, 0.5, 0.1, 0.01, or 0.001.

In some embodiments, a ratio of the area of the emitting field of view 101 to the area of the receiving field of view 102 is smaller than the first ratio threshold, and the first ratio threshold may be, but is not limited to, 0.5, 0.1, 0.01, or 0.001.

In some embodiments, for two successive groups of the emitted light, from the emission start moment at which a preceding group of the emitted light is emitted until an end of the preset receiving duration after the latter group of the emitted light is emitted, a ratio of a direction angle change magnitude between two adjacent emitting fields of view 101 along a length direction of the dot array to a direction angle change magnitude of the receiving field of view 102 is greater than a second ratio threshold, and the second ratio threshold is not smaller than 1. For example, the second ratio threshold may be, but is not limited to, 1, 10, 100, 10,000, or 1,000,000, that is, the positions of the receiving field of view 102 corresponding to the emitting fields of view 101 are different, and a position change magnitude of the emitting fields of view 101 is greater than or equal to a position change magnitude of the receiving field of view 102. It should be noted that the “direction angle change magnitude between two adjacent emitting fields of view 101” generally refers to an included angle between directions that two adjacent groups of the emitted light along the length direction of the dot array are projected to the target scene 700; similarly, the “direction angle change magnitude of the receiving field of view 102” generally refers to an angle at which the receiving field of view 102 is deflected along the designated direction each time. Hereinafter, taking the length direction of the receiving field of view 102 being the vertical direction and the designated direction being the horizontal direction as an example, assuming that the included angle between an optical path direction of the first group of emitted light emitted to the target scene 700 and the vertical direction is α₁, and the included angle between the optical path direction of the second group of emitted light emitted to the target scene 700 and the vertical direction is α₂, then, for the first group of emitted light, from the emission start moment of the first group of emitted light, the projection area of the first group of emitted light in the target scene 700, i.e., the emitting field of view 101 of the first group of emitted light, is located in the current receiving field of view 102 within the preset receiving duration. From the emission start moment at which the first group of emitted light is emitted to the emission start moment at which the second group of emitted light is emitted, a deflection angle of the current receiving field of view 102 along the horizontal direction is γ₁; and for the second group of emitted light, due to the change of the position of the receiving field of view 102, from the emission start moment at which the second group of emitted light is emitted to the emission start moment at which the third group of emitted light is emitted, the deflection angle of the current receiving field of view 102 along the horizontal direction changes to γ₂, the projection area of the second group of emitted light in the target scene 700, i.e., the emitting field of view 101 of the second group of emitted light, is located in the current receiving field of view 102 within the preset receiving duration. Here, (α₂−α₁)÷(γ₂−γ₁)≥T, where T represents the second ratio threshold.

In some embodiments, a ratio of the area of the emitting field of view 101 to an area of the target scene 700 is smaller than a third ratio threshold, and the third ratio threshold is not greater than 0.1, e.g., the third ratio threshold may be, but is not limited to, 0.1, 0.01, 0.001, 0.0001, or 0.0001.

As shown in FIG. 8, the emitted light includes multiple light pulses, at least two of the light pulses of the emitted light have an included angle greater than a preset included angle α; where a ratio of the preset included angle α to a field angle β of the receiving field of view 102 is smaller than a fourth ratio threshold, the fourth ratio threshold is not smaller than 0.01, e.g., the fourth ratio threshold may be, but is not limited to, 0.01, 0.1, 0.3, 0.5 or 0.9.

In some embodiments, a ratio of the area of the target scene 700 to the area of the receiving field of view 102 is greater than or equal to a fifth ratio threshold, the fifth ratio threshold is not smaller than 2, e.g., the fifth ratio threshold may be, but is not limited to, 2, 4, 8, 16, 100, 1000 or 10000.

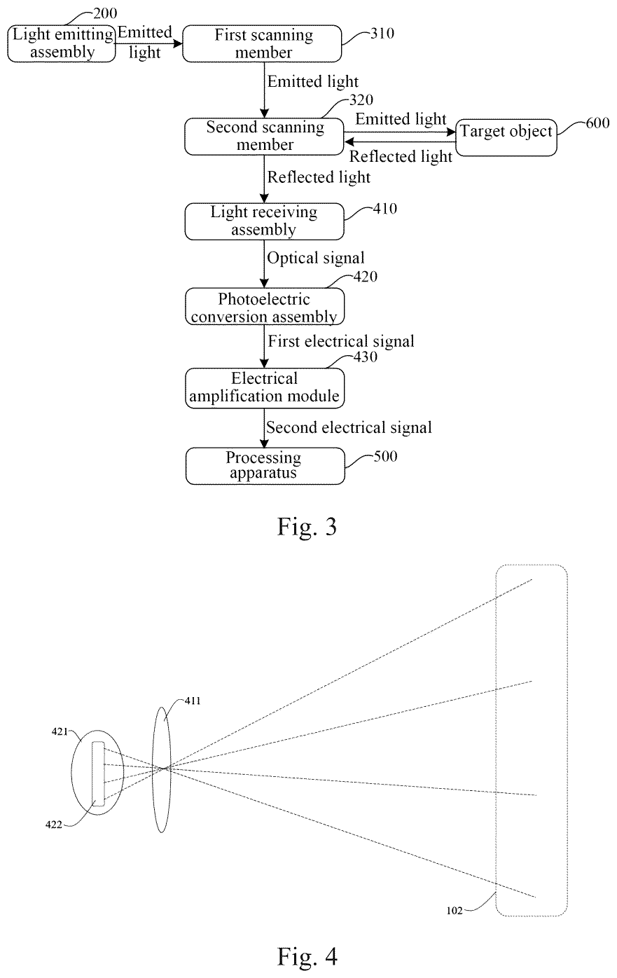

As shown in FIG. 3, the receiving end assembly 400 includes a light receiving assembly 410 and a photoelectric conversion assembly 420; where the light receiving assembly 410 is configured to sequentially receive multiple groups of reflected light reflected by the target object 600 and sequentially convert the multiple groups of reflected light into corresponding first optical signals; and the photoelectric conversion assembly 420 is configured to sequentially convert the first optical signals into corresponding first electrical signals.

In the case where the receiving field of view 102 is a whole bar-shaped continuous area: in order to make the receiving field of view 102 a bar-shaped continuous area, the photoelectric conversion assembly 420 may take the following structural form, for example:

As shown in FIG. 4, the photoelectric conversion assembly 420 includes a photoelectric conversion member 421 and an optical element 422; where the photoelectric conversion member 421 has a continuous photoelectric conversion area, a light inlet end of the optical element 422 faces the light receiving assembly 410 and a light outlet end of the optical element 422 faces the photoelectric conversion area; and the light outlet end of the optical element 422 is in the shape of a bar, and a length direction of the optical element 422 is adapted to the length direction of the receiving field of view 102, the optical element 422 is configured to selectively transmit the first optical signals to the photoelectric conversion area, and the photoelectric conversion area is configured to convert the first optical signals into the first electrical signals. Here, the optical element 422 may include, but is not limited to, at least one of a microlens array, at least one diaphragm, a light cone 425 or a light conductor. It should be noted that “the light outlet end of the optical element 422 is in the shape of a bar, and a length direction of the optical element 422 is adapted to the length direction of the receiving field of view 102” generally refers to the length direction of the optical element 422 corresponding to the length direction of the receiving field of view 102. For example, if the reflected light reflected by the target object 600 is not deflected by the light scanning assembly 300, and also the light receiving assembly 410 does not deflect the reflected light, that is, the light receiving assembly 410 does not include a deflector lens, such as a 45° reflector, then the length direction of the optical element 422 is parallel to the length direction of the receiving field of view 102. If the reflected light reflected by the target object 600 is deflected by the light scanning assembly 300 or the light receiving assembly 410, for example, by 45°, then the length direction of the optical element 422 is no longer parallel to the length direction of the receiving field of view 102, but is parallel to a length direction formed by deflecting the receiving field of view 102 by 45°, i.e., in this regard, an included angle between the length direction of the optical element 422 and the length direction of the receiving field of view 102 is greater than zero.

Taking the length direction of the receiving field of view 102 being the vertical direction and the optical element 422 being a diaphragm as an example, as shown in FIG. 4, the light receiving assembly 410 is a receiving lens 411, the diaphragm is disposed between the photoelectric conversion member 421 and the receiving lens 411, and an area of the photoelectric conversion area of the photoelectric conversion member 421 is greater than or equal to an area of the diaphragm. Since the light inlet end of the diaphragm faces the receiving lens 411 and the light outlet end of the diaphragm faces the photoelectric conversion area of the photoelectric conversion member 421, at least part of the reflected light emitted from the area defined by the dashed rectangular box in the target scene 700 in FIG. 4 may be directly irradiated to the light inlet end of the diaphragm after through the receiving lens 411, first optical signals emitted from the light outlet end of the diaphragm may be received by the photoelectric conversion area of the photoelectric conversion member 421, and the photoelectric conversion area converts the first optical signals into first electrical signals. Since the light outlet end of the diaphragm is bar-shaped and the length direction is adapted to the length direction of the receiving field of view 102, and the photoelectric conversion member 421 has a continuous photoelectric conversion area on the side facing the receiving lens 411, at least part of the reflected light emitted from any position in the area defined by the dashed rectangular box in FIG. 4 can be irradiated to the photoelectric conversion member 421 through the diaphragm and converted into the first electric signals by the photoelectric conversion area of the photoelectric conversion member 421. As can be seen, the receiving field of view 102 of the receiving end assembly 400 in an embodiment of the present disclosure is the area defined by the dashed rectangular box in FIG. 4. Moreover, it can be seen from the above that in an embodiment of the present disclosure, after being transmitted through the receiving lens 411 and the diaphragm sequentially, the reflected light only needs to be irradiated to any position in the photoelectric conversion area, only one photoelectric conversion member 421 needs to be arranged on a transmittance path of the diaphragm, and there is no need to quickly and accurately control the reflection direction of the reflected light, that is, there is no need to irradiate the reflected light to a particular position in the photoelectric conversion assembly 420, thereby significantly reducing the complexity of the entire laser system 100.

In the case where the receiving field of view 102 includes multiple bar-shaped continuous areas: in order to achieve the bar-shaped continuous areas of the receiving field of view 102, the photoelectric conversion assembly 420 may take the following structural form, for example:

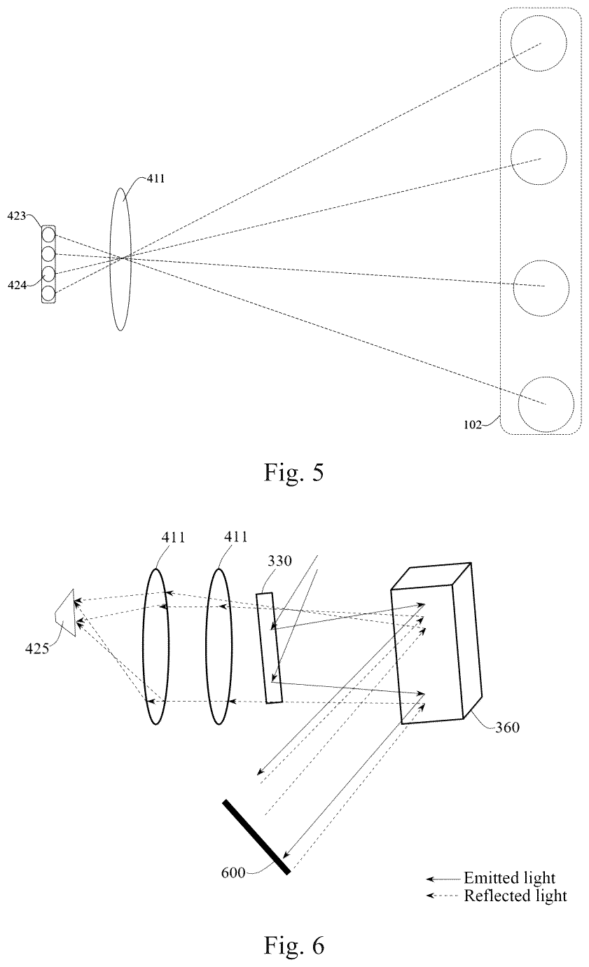

Form I, as shown in FIG. 5, the photoelectric conversion assembly 420 includes a photoelectric unit array 423 and at least one optical element 422; where the optical element 422 is disposed between the light receiving assembly 410 and the photoelectric unit array 423, the photoelectric unit array 423 includes multiple photoelectric conversion units disposed sequentially along a preset direction; the optical element 422 is configured to deflect a part of the first optical signals, emitted by the light receiving assembly 410 to a direction between two adjacent photoelectric conversion units 424, to the photoelectric conversion units 424, and the photoelectric conversion units 424 are configured to convert the first optical signals into the first electrical signals. Here, the preset direction is adapted to the length direction of the receiving field of view 102. It should be noted that here, “the preset direction is adapted to the length direction of the receiving field of view 102” is similar to the above, that is, whether or not the preset direction is parallel to the length direction of the receiving field of view 102 is dependent on whether or not the reflected light is deflected by the light scanning assembly 300 and/or the light receiving assembly 410 before being irradiated to the photoelectric unit array 423. Here, the photoelectric conversion units 424 may be, but are not limited to, at least one of an APD (full name is Avalanche Photo Diode), a SPAD (full name is Single Photon Avalanche Diode), a SIPM (full name is Silicon photomultiplier), a PIN diode, or a

PD (full name is Photo-Diode). A photosensitive material of the photoelectric conversion units 424 includes at least one of Si, GaAs, InP, or InGaAs. Here, the optical element 422 may include, but is not limited to, at least one of a microlens array, at least one diaphragm, a light cone, or a light conductor.

Taking the length direction of the receiving field of view 102 being the vertical direction and the optical element 422 being a microlens array as an example, as shown in FIG. 5, the light receiving assembly 410 is a receiving lens 411, the microlens array (not shown in the figure) is disposed between the photoelectric conversion member 421 and the receiving lens 411, and the length direction of the microlens array is parallel to the vertical direction. At least part of the reflected light emitted from the area defined by the dashed rectangular box in the target scene 700 in FIG. 5 is irradiated to the microlens array after passing through the receiving lens 411, and due to the microlens array, the first optical signals emitted to a direction between two adjacent photoelectric conversion units 424 are emitted to a nearby photoelectric conversion unit 424 after being refracted and deflected by a corresponding microlens in the microlens array.

Form II, the photoelectric conversion assembly 420 includes a photoelectric unit array 423, the photoelectric unit array 423 includes multiple photoelectric conversion units disposed sequentially along a preset direction, and the photoelectric conversion units 424 are configured to convert the first optical signals into the first electrical signals. Here, the preset direction is adapted to the length direction of the receiving field of view 102. In this case, the receiving end assembly 400 further includes electrical amplification modules 430, the number of the electrical amplification modules 430 is smaller than the number of the photoelectric conversion units 424 in the photoelectric unit array 423, and output ends of at least two of the photoelectric conversion units 424 are connected to an input end of a given electrical amplification module 430.

Taking the length direction of the receiving field of view 102 being the vertical direction as an example, since the photoelectric unit array 423 includes multiple photoelectric conversion units 424 sequentially disposed along the vertical direction, at least a part of the reflected light emitted from any position in the area defined by the dashed rectangular box in the target scene 700 in FIG. 5 can irradiate the multiple photoelectric conversion units 424 after passing through the receiving lens 411, and the photoelectric conversion units 424 convert the received first optical signals into the first electrical signals. Assuming that the output ends of these photoelectric conversion units 424 are connected to the input end of a given electrical amplification module 430, then if the first electrical signals are pulsed electrical signals, all of the first electrical signals generated by the conversion of these photoelectric conversion units 424 are sequentially input into the corresponding electrical amplification module 430 to form a continuous electrical wave signal, and the electrical wave signal is amplified by the electrical amplification module 430 to form a second electrical signal with a continuous waveform. Thus, one of the continuous areas of the receiving field of view 102 in an embodiment of the present disclosure is the area defined by the dashed rectangular box in FIG. 5.

Form III, the photoelectric conversion assembly 420 includes a photoelectric unit array 423, the photoelectric unit array 423 includes multiple photoelectric conversion units disposed sequentially along a preset direction, and the photoelectric conversion units 424 are configured to convert the first optical signals into the first electrical signals. Here, the preset direction is adapted to the length direction of the receiving field of view 102. In this case, the receiving end assembly 400 further includes electrical amplification modules 430, the number of the electrical amplification modules 430 is greater than or equal to the number of the photoelectric conversion units 424 in the photoelectric unit array 423; the output end of each of the photoelectric conversion units 424 is electrically connected to the input end of at least one of the electrical amplification modules, and output ends of at least two electrical amplification modules connected to different photoelectric conversion units 424 are connected to form a total output end. Hereinafter, taking the number of the electrical amplification modules 430 being equal to the number of the photoelectric conversion units 424 in the photoelectric unit array as an example, assuming that the photoelectric conversion units 424 are electrically connected to the input ends of different electrical amplification modules 430 respectively, i.e., when the electrical amplification modules 430 correspond one-to-one with the photoelectric conversion units 424 in the photoelectric unit array 423, the output ends of at least two electrical amplification modules 430 are connected to form the total output end. As a result, whenever the first electrical signals are pulsed electrical signals, the first electrical signals generated by the photoelectric conversion units 424 are sequentially input into the corresponding electrical amplification modules 430. For the at least two electrical amplification modules 430 whose output ends are connected to each other, the pulsed electrical signals obtained by amplifying the first electrical signals input to these electrical amplification modules 430 by using the corresponding electrical amplification modules 430 are output sequentially from the total output end, so that the signals output from the total output end may form the second electrical signal with a continuous waveform. As can be seen, one continuous area of the receiving field of view 102 in an embodiment of the present disclosure is the area defined by the dashed rectangular box in FIG. 5.

In some embodiments, the light receiving assembly 410 includes at least one lens group, and the lens group includes at least one receiving lens 411 disposed on an optical path of the reflected light. In the case where the light receiving assembly 410 includes multiple lens groups, the multiple lens groups are disposed sequentially along the designated direction. Thus, at least part of the reflected light emitted from any position of the receiving field of view 102 can be irradiated to at least one of the lens groups, and the reflected light passes through the receiving lens 411 of this lens group and is finally converted into the first electrical signals by the photoelectric conversion assembly 420. When the length direction of the receiving field of view 102 is parallel to the vertical direction, a lens surface of the receiving lens 411 may be either parallel to the vertical direction or form an included angle with the vertical direction, for example, the lens surface of the receiving lens 411 may be inclined at 45° with respect to the vertical direction.

As shown in FIG. 2, the laser system 100 in an embodiment of the present disclosure further includes a scanning control member, a light scanning assembly 300, and a processing apparatus 500; where the scanning control member is configured to generate a scanning control signal; the light scanning assembly 300 is configured to deflect the emitted light emitted by the light emitting assembly 200 according to the scanning control signal, to be irradiated to at least one of the target object 600 in the target scene 700, and/or deflect at least one group of the reflected light reflected by at least one of the target object 600 to be received by the receiving end assembly 400; and the processing apparatus 500 is electrically connected to the light emitting assembly 200, the scanning control member, and the receiving end assembly 400 respectively, and the processing apparatus 500 is configured to determine at least one of a distance to the target object 600, a directional angle of the target object 600, a reflectivity of the target object 600, or a contour of the target object 600, based on the emitting signal and/or the output signal.

In order to expand a scanning range of the light scanning assembly 300, the light scanning assembly 300 includes multiple light scanning members sequentially disposed along an optical path of the emitted light, one in two adjacent light scanning members of the light scanning members deflects the emitted light, to be emitted to the other light scanning member; where at least two of the light scanning members have different scanning modes; where the scanning modes include at least one of an area of a reflective surface, a scanning direction, a scanning angle range, a scanning frequency or a scanning dimension of the light scanning member. Here, the scanning dimension of the light scanning assembly 300 may be, but is not limited to, one dimensional or two dimensional.

The following is an example of two-dimensional scanning, as shown in FIG. 3, the multiple light scanning members includes a first scanning member 310 and a second scanning member 320, the scanning direction of the first scanning member 310 is different from the scanning direction of the second scanning member 320, and the designated direction above is a first scanning direction, in particular, the first scanning member 310 sequentially deflects, within the current frame scanning duration, multiple groups of the emitted light along a second scanning direction, to be emitted to the second scanning member 320; and the second scanning member 320 deflects along the first scanning direction the light deflected by the first scanning member 310, to be irradiated to the target object 600; where the second scanning direction is parallel to the length direction of the receiving field of view 102, and the first scanning direction is different from the second scanning direction. Compared to directly using an expensive two-dimensional scanning member such as a 2D MEMS mirror 330, an embodiment of the present disclosure can achieve two-dimensional scanning and expand the scanning range of the light scanning assembly 300 at a reduced cost by using two one-dimensional scanning members, i.e., the first scanning member 310 and the second scanning member 320, to perform a composite scanning.

In some embodiments, the first scanning member 310 and the second scanning member 320 may include, but are not limited to, at least one of a MEMS mirror, a rotating prism, a rotating wedge, an optical phased array, a photoelectric deflection device, or a liquid crystal scanning member; and the liquid crystal scanning member includes a liquid crystal spatial light modulator, a liquid crystal superlattice surface, a liquid crystal line controlled array, a transmissive one-dimensional liquid crystal array, a transmissive two-dimensional liquid crystal array, or a liquid crystal display module. The first scanning direction and the second scanning direction may be, but are not limited to, a horizontal direction, a vertical direction, or an inclined direction; where the inclined direction is between the vertical direction and the horizontal direction.

For example, as shown in FIG. 6, the first scanning member 310 is the MEMS mirror 330, the second scanning member 320 is a rotating lens 360, the first scanning direction is the horizontal direction, and the second scanning direction is the vertical direction. Here, the rotating lens 360 may be, but is not limited to, a rotating prism or a rotating wedge. Since the scanning frequency of the MEMS mirror 330 is fast and the scanning frequency of the rotating lens 360 is slow, the MEMS mirror 330 quickly deflects multiple groups of emitted light sequentially along the vertical direction to the rotating lens 360, then the rotating lens 360 deflects the received multiple groups of emitted light sequentially along the horizontal direction to the target object 600 at a large horizontal scanning angle, that is, trajectories of the multiple groups of emitted light deflected by the rotating lens 360 to the target object 600 form a sectorial surface with a large central angle of the circle on a horizontal plane. Thus, the entire light scanning assembly 300 can achieve vertical high-frequency scanning+horizontal wide-angle scanning, thereby not only improving a scanning resolution, but also increasing a receiving area of the reflected light, that is, through the reflection of the rotating lens 360 with respect to the light reflected by the target object 600, the area of the photoelectric conversion assembly 420 to which the reflected light passing through the light receiving assembly 410 is irradiated can be increased. In addition, since costs of the rotating lens 360 is much lower than costs of the MEMS mirror 330, and the MEMS mirror 330 scans faster, by sequentially deflecting the emitted light using the MEMS mirror 330 and the rotating lens 360, not only the receiving field of view of the light receiving assembly 410 can be expanded at a low cost, but also a discriminatory ability of the laser system on the target scene 700 can be improved.

Of course, the light scanning assembly 300 may take other structural forms in order to achieve two-dimensional scanning:

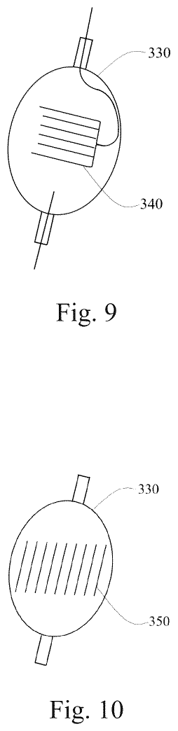

For example, as shown in FIG. 9, the light scanning assembly 300 includes a MEMS mirror 330 and an optical phased array 340, the optical phased array 340 is fixed to a reflective surface of the MEMS mirror 330, a light inlet of the optical phased array 340 is connected to the light emitting assembly 200 via a cable, and a light outlet of the optical phased array 340 faces the target object 600. Here, the optical phased array 340 (abbreviated as OPA) includes multiple waveguides distributed in an array, and a material of the waveguides includes at least one of silicon crystal, silicon oxide, or silicon nitride. Thus, in response to the scanning control signal generated by the scanning control member, the optical phased array 340 change relative feed phases of the waveguides accordingly to generate a phase difference, and the phase difference causes the emitted light to interfere and change a direction of the optical path. At the same time, in response to the scanning control signal, the lens surface of the MEMS mirror 330 performs minor translational and torsional reciprocating motions, and since the optical phased array 340 is fixed to the reflective surface of the MEMS mirror 330, the optical phased array 340 as a whole performs a motion synchronously with the lens surface of the MEMS mirror 330, thereby enabling the optical phased array 340 to achieve omni-directional scanning. As can be seen, by fixing the optical phased array 340 to the reflective surface of the MEMS mirror 330 in an embodiment of the present disclosure, the optical phased array 340 may be allowed to scan based on the phase difference while rotating itself as a whole, thereby expanding the scanning range of the light scanning assembly 300 and increasing a scanning rate.

As another example, as shown in FIG. 10, the light scanning assembly 300 includes a MEMS mirror 330 and an optical grating array 350, the optical grating array 350 is fixed to a reflective surface of the MEMS mirror 330; where the emitting signal further includes wavelength information indicating a wavelength of each group of the emitted light, and a deflection direction of the emitted light is determined based on the wavelength information. Since a direction of a reflected light beam of the optical grating array 350 is related to the wavelength of an incident light beam, the light emitting assembly 200 emits the emitted light of a designated wavelength based on the wavelength information, and the emitted light is reflected according to the corresponding direction after being irradiated to the optical grating array 350. At the same time, in response to the scanning control signal, the lens surface of MEMS mirror 330 performs minor translational and torsional reciprocating motions, and since the optical grating array 350 is fixed to the reflective surface of the MEMS mirror 330, the optical grating array 350 as a whole performs a motion synchronously with the lens surface of the MEMS mirror 330, thereby enabling the optical grating array 350 to achieve omni-directional scanning. As can be seen, by fixing the optical grating array 350 to the reflective surface of the MEMS mirror 330 in an embodiment of the present disclosure, the optical grating array 350 may be allowed to change the direction of the optical path of the emitted light based on the wavelength of the emitted light while rotating itself as a whole, thereby expanding the scanning range of the light scanning assembly 300 and increasing the scanning rate.

In some embodiments, the light scanning assembly 300 is further configured to generate a current scanning angle signal while deflecting the reflected light reflected by the target object 600. The current scanning angle signal may be a horizontal scanning angle signal: for example, in the case where the light scanning assembly 300 includes the rotating lens 360, the rotating lens 360 is provided with a code disc. The code disc detects a current horizontal scanning angle of the rotating lens 360 in real time and sends a detection result, i.e., the current scanning angle signal, to the processing apparatus 500. As another example, in the case where the light scanning assembly 300 includes the MEMS mirror 330, the MEMS mirror 330 is provided with a torque detector. The torque detector detects a torque of the MEMS mirror 330 in real time, and converts the torque of the MEMS mirror 330 into the current scanning angle signal and sends the current scanning angle to the processing apparatus 500. The processing apparatus 500 is further configured to determine, based on at least one of the emitting signal, the scanning control signal, the current scanning angle signal, the output signal, or a position where the first electrical signals are output on the photoelectric conversion assembly 420, an irradiation angle at which the emitted light is irradiated to the target object 600. For example, in the case where the photoelectric conversion assembly 420 includes multiple photoelectric conversion units 424, the “position where the first electrical signals are output on the photoelectric conversion assembly 420” generally refers to a position where the photoelectric conversion units 424 outputting the first electrical signals are located.

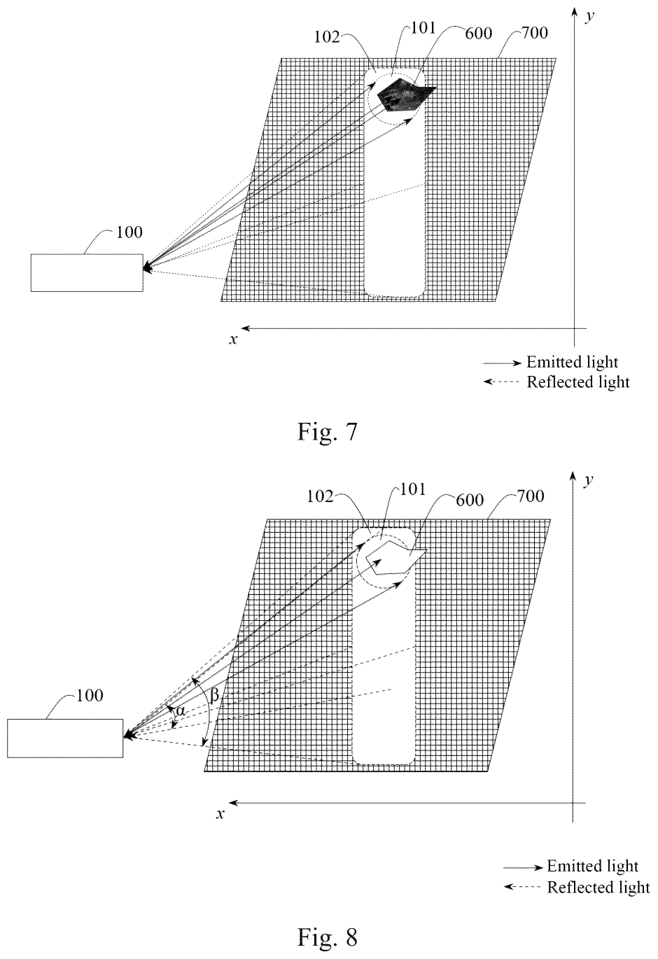

As shown in FIG. 7, in order to expand an application field of the laser system 100 so that it can be applied in the fields of AR, VR and meta-universe, the multiple groups of the emitted light includes at least one group of first emitted light and at least one group of second emitted light, the emission start moment of the first emitted light is earlier than the emission start moment of the second emitted light, the reflected light reflected by the target object 600 corresponding to the first emitted light is converted into the output signal, and the second emitted light is visible light, that is, the first emitted light is used to measure at least one of the distance, the reflectivity, or the contour, and the second emitted light is used to project an image. The light scanning assembly 300 is configured to, after irradiating the first emitted light to the multiple target objects 600, project the second emitted light onto a surface of one of the multiple target objects 600 according to a preset effect based on at least one of the distance, the irradiation angle, the reflectivity, or the contour. Since the second emitted light is projected onto the surface of the target object 600 based on at least one of the distance to the target object 600, the irradiation angle, the reflectivity of the target object 600, or the contour of the target object 600, imaging of the second emitted light on the surface of the target object 600 may reproduce a real image.

For example, when the surface of the target object 600 is a spherical surface, the light emitting assembly 200 first emits at least one group of first emitted light to the surface of the target object 600 via a probe assembly, then emits at least one group of second emitted light. The processing apparatus 500 determines at least one of the distance to the target object 600, the reflectivity of the target object 600, or the contour of the target object 600 based on the emitting signal and/or the output signal corresponding to the first emitted light, at the same time, the processing apparatus 500 further determines the irradiation angle at which the emitted light is irradiated to the target object 600 based on at least one of the scanning control signal, the current scanning angle signal, the output signal, or the position where the first electrical signals are output on the photoelectric conversion assembly 420. Then, the light scanning assembly 300 projects the second emitted light, such as an insect image, onto the surface of the target object 600 based on at least one of the distance to the target object 600, the irradiation angle, the reflectivity of the target object 600, or the contour of the target object 600 determined by the processing apparatus 500 based on the first emitted light. Since the second emitted light is projected onto the surface of the target object 600 based on at least one of the distance to the target object 600, the irradiation angle, the reflectivity of the target object 600, or the contour of the target object 600, the insect image is not distorted by a curved surface of the target object 600, but is instead overlaid on the curved surface of the target object 600 according to a certain curvature, so that the target object 600 realistically reproduces the insect. Here, the second emitted light may include, but is not limited to, at least one of red light, blue light, or green light.

As another example, when the target object 600 is a car windshield or AR glasses, the light scanning assembly 300 first projects the first emitted light onto the car windshield or the AR glasses, and then projects a preset virtual AR image, i.e., the second emitted light, on the car windshield or the AR glasses based on at least one of the distance to the target object 600, the irradiation angle, the reflectivity of the target object 600, or the contour of the target object 600, so as to enable users to see enhanced views of the real world and the virtual world.

Of course, the light scanning assembly 300 may also directly project the first emitted light and the second emitted light onto the surfaces of two different target objects 600, in which case the laser system 100 is equivalent to an ordinary projection device.

In some embodiments, the current scanning angle signal includes a first scanning angle signal; where the first scanning angle signal is a scanning angle signal generated when the light scanning assembly 300 deflects the reflected light along the first scanning direction; the processing apparatus 500 is configured to determine a component of the irradiation angle along the first scanning direction based on the first scanning angle signal, and at the same time, the processing apparatus 500 is further configured to determine a component of the irradiation angle along the second scanning direction based on at least one of the scanning control signal, the current scanning angle signal, the output signal, or the position where the first electrical signals are output on the photoelectric conversion assembly 420; where the designated direction is the first scanning direction. For example, the second scanning member 320 is the rotating lens 360, since the scanning frequency of the rotating lens 360 is slow, the second scanning member 320 feeds back the first scanning angle signal to the processing apparatus 500 after deflecting the first scanning angle signal with a designated angle based on the scanning control signal, and the processing apparatus 500 can determine the component of the irradiation angle of the target object 600 along the first scanning direction based on the first scanning angle signal. Of course, when the scanning frequency of the first scanning member 310 is slow, the current scanning angle signal includes a second scanning angle signal, and the processing apparatus 500 may also determine the component of the irradiation angle along the second scanning direction directly based on the second scanning angle signal.

In some embodiments, the laser system 100 further includes a communication component, and the communication component is configured to transmit designated information to the outside and/or receive external information; where the designated information includes at least one of the distance to the target object, the reflectivity of the target object, the directional angle of the target object, the contour of the target object, or the irradiation angle.

The processing apparatus 500 is further configured to determine at least one of a three-dimensional fusion image of the target object 600, a superpixel 802 of the target object 600, a superpixel 803 of the receiving field of view, the first designated rule, or the second designated rule, based on a target parameter; where the target parameter includes at least one of the emitting signal, the scanning control signal, the current scanning angle signal, the output signal, the position where the first electrical signals are output on the photoelectric conversion assembly 420, or the external information. It should be noted that “superpixel 802 of the target object 600” generally refers to a set of multiple pixels among all pixels constituting an image of the target object;

“superpixel 803 of the receiving field of view” generally refers to a set of multiple pixels among all pixels constituting an image of the receiving field of view. Here, a shape of the superpixel 802 of the target object and a shape of the superpixel 803 of the receiving field of view may include, but is not limited to, at least one of a straight line, a polygon, a circle, or an ellipse.

In some embodiments, the laser system 100 further includes an image sensor, and the image sensor is configured to acquire a two-dimensional image of the target scene 700; and the target parameter includes the two-dimensional image. The communication component is further configured to transmit the superpixel 802 of the target object to the outside.

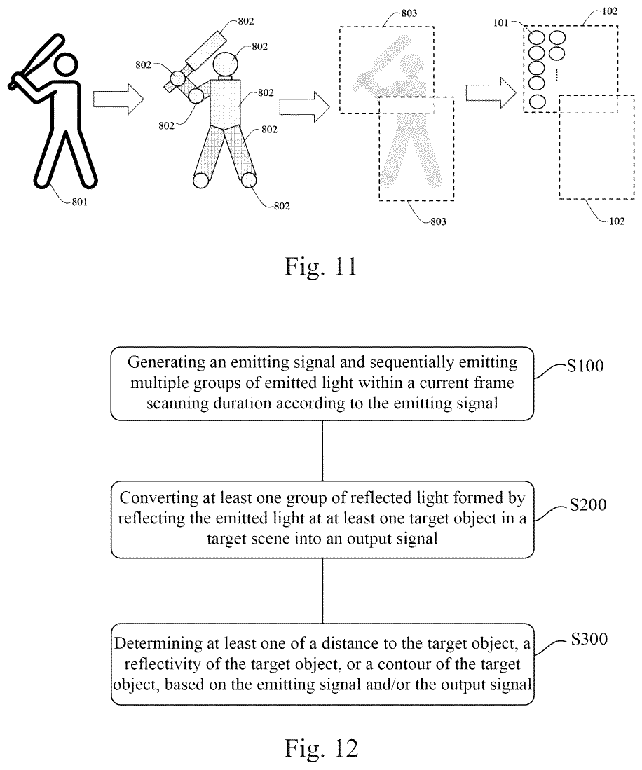

The following is an example of determining the superpixel 803 of the receiving field of view. As shown in FIG. 11, the light emitting assembly 200 sequentially emits multiple groups of emitted light within the current frame scanning duration, and the light scanning assembly 300 sequentially deflects the multiple groups of the emitted light emitted by the light emitting assembly 200 according to the scanning control signal and then irradiates the deflected light to the target object 600 in the target scene 700. The processing apparatus 500 determines a three-dimensional point cloud image 801 of the target object based on at least one of the emitting signal, the scanning control signal, the current scanning angle signal, the output signal, the position where the first electrical signals are output on the photoelectric conversion assembly 420, or the external information, and the processing apparatus 500 performs a superpixel segmentation on the three-dimensional point cloud image 801 of the target object 600, segments the image into 13 parts of superpixel 802 of the target object in FIG. 11, and then generates the superpixel 803 of the two receiving fields of view based on the 13 parts of superpixel 802 of the target object. Within a next frame scanning duration, the receiving field of view 102 is first located at the position of the superpixel 803 of the receiving field of view above, and the light emitting assembly 200 first sequentially emits multiple groups of emitted light to the receiving field of view 102, so that the projection area of each group of emitted light in the target scene 700, i.e., the emitting fields of view 101 are arranged in a dox array and are located exactly within the receiving field of view 102; next, the receiving field of view 102 moves to the position of the superpixel 803 of the receiving field of view below according to the first designated rule, and the light emitting assembly 200 then sequentially emits multiple groups of emitted light to the current receiving field of view 102, so that the emitting fields of view 101 are arranged in the dot array and are located exactly within the receiving field of view 102.

In some embodiments, the receiving end assembly 400 includes the light receiving assembly 410 and the photoelectric conversion assembly 420; where the light receiving assembly 410 is configured to sequentially receive multiple groups of reflected light reflected by the target object 600 and sequentially convert the multiple groups of reflected light into corresponding first optical signals; and the photoelectric conversion assembly 420 is configured to sequentially convert the multiple first optical signals into corresponding first electrical signals. In this case, the first electrical signals serve as the output signal.

Of course, considering that a signal intensity of the first electrical signals may be weak, in order to improve a measurement accuracy, in some embodiments, the receiving end assembly 400 then includes the light receiving assembly 410, the photoelectric conversion assembly 420 and the electrical amplification modules 430; where the light receiving assembly 410 is configured to sequentially receive multiple groups of reflected light reflected by the target object 600 and sequentially convert the multiple groups of reflected light into corresponding first optical signals; the photoelectric conversion assembly 420 is configured to sequentially convert the multiple first optical signals into corresponding first electrical signals, and the electrical amplification modules 430 are configured to amplify the first electrical signals into a second electrical signal. In this case, the second electrical signal serves as the output signal.

In addition, it should be noted that the processing apparatus 500 may determine at least one of the distance to the target object 600, the reflectivity of the target object 600, or the contour of the target object 600 based on a variety of methods, e.g., the processing apparatus 500 may determine the distance to the target object 600 based on methods such as time-of-flight method, phased method ranging, or triangulated method ranging.

In the case where the processing apparatus 500 determines the distance to the target object 600 based on the time-of-flight method, the processing apparatus 500 includes a processor, at least one comparator, and a duration determination module corresponding one-to-one with the comparator. Here, the electrical amplification modules 430 include multiple amplifiers connected in series or in parallel, at least one amplifier of the multiple amplifiers outputs an amplified electrical signal having an intensity smaller than a half of an intensity of an amplified electrical signal output by another amplifier of the amplifiers. Here, at least an output end of the amplifier outputting a maximal amplified electrical signal is connected to an input end of at least one comparator, and a comparison input of the comparator corresponds one-to-one with the amplifier. For example, when the multiple amplifiers are connected in series in sequence, the amplified electrical signal output from a last-layer amplifier is the largest, and if the number of comparators is one, then in the case where the number of comparators is one, this comparator is connected to the duration determination module via the last-layer amplifier; when the number of comparators is more than one, the output ends of the multiple amplifiers are connected to comparators, and each comparator has a different voltage value for the comparison input. The comparator accesses the comparison input, and is configured to compare the voltage value of the comparison input with the electrical signal output by the corresponding amplifier, to determine a trigger start moment, a trigger end moment and a pulse width; where the trigger start moment and the trigger end moment are respectively a start moment and an end moment of a period that the intensity of the electrical signal output by the amplifier is higher than the voltage value of the comparison input, and the pulse width is a difference between the trigger end moment and the trigger start moment; the duration determination modules correspond one-to-one with the comparators; and the duration determination module is configured to determine a light flight duration based on the emission start moment and the trigger start moment output by the corresponding comparator. The processor determines at least one of the distance, the reflectivity, or the contour based on at least one of the light flight duration, the pulse width, an intensity of the second electrical signal, or speed of light.

Taking measurement of the distance to the target object 600 as an example, in this case, the processor determines the distance to the target object 600 based on the time-of-flight method. Since the trigger start moment is affected by the magnitude of the voltage value of the comparison input, and if the voltage value of the comparison input for the electrical signal output by the triggering amplifier is different, the corresponding pulse width is also different, in order to reduce the above influence, the processor first corrects the light flight duration based on the pulse width, and then determines the distance to the target object 600 based on the speed of light and the corrected light flight duration.

Here, the comparison input may be a dynamic voltage curve input into the comparator from the outside or may be a dynamic voltage curve prestored in the comparator. In addition, the duration determination module may be, but is not limited to, a TDC (time-to-digital converter). The duration determination module and the processor may both be separate components or may be integrated into one component.

In some embodiments, the laser system 100 in an embodiment of the present disclosure further includes a main housing and at least one probe housing, the probe housing is separated with the main housing, and the probe housing corresponds one-to-one with the target scene. Here, the main housing is provided with the light emitting assembly 200, the scanning control member and the processing apparatus 500; and the probe housing is provided with the light receiving assembly 410 and the light scanning assembly 300; where the photoelectric conversion assembly 420 is arranged in the main housing or the probe housing.

In an embodiment of the present disclosure, since the probe housing is separated with the main housing, the probe housing and the main housing may be fixedly mounted separately, the probe housing is small in size compared to the entire laser system 100, the probe housing can be mounted on a small-sized application object or small-sized application location. Taking the application object being a blind person's glasses as an example, the probe housing may be fixed onto a frame of the blind person's glasses, and the main housing is clamped on the user's waist or placed in the user's clothing pocket. Taking the application object being a rear-view mirror of a car as another example, the probe housing may be fixed to the rear-view mirror of the car, and the main housing is fixed to the ceiling of the car. As can be seen, when mounting the laser system 100, only the probe housing needs to be mounted on the application object or the application location, instead of mounting the entire laser system 100 on the application object or the application location, thereby expanding a scope of application of the laser system 100. In addition, since the light scanning assembly 300 which emits emitted light to the target object 600, and the light receiving assembly 410 which receives reflected light from the target object 600, are both arranged on the probe housing, whereas the probe housing is mounted on the application object or the application location, it may be ensured that a detection range of the entire laser system 100 is not compromised.

In the case of multiple probe housings, the light scanning assemblies 300 within the probe housings may each irradiate corresponding emitted light to the target object 600 in a different target scene 700.

In some embodiments, the light emitting assembly 200 is connected to the light scanning assembly 300 via a first optical fibre, the light receiving assembly 410 is connected to the photoelectric conversion assembly 420 via a second optical fibre, and the processing apparatus 500 is electrically connected to the light emitting assembly 200, the scanning control member, the photoelectric conversion assembly 420 and the light scanning assembly 300, respectively via cables. It should be noted that the above components may be optically/electrically connected with the help of other optical elements 422 and wireless communication elements for transmitting electrical signals and/or optical signals through space, in addition to being optically/electrically connected with the help of optical fibres or cables.

In some embodiments, the laser system 100 further includes a display component and/or a prompting component; where the display component is configured to display at least one of the distance to the target object 600, the irradiation angle, the reflectivity of the target object 600, or the contour of the target object 600; and the prompting component is configured to output a prompting signal based on at least one of the distance to the target object 600, the irradiation angle, the reflectivity of the target object 600, or the contour of the target object 600. Here, the prompting component may be, but is not limited to, a microphone or a vibrator.

In some embodiments, the receiving end assembly 400 further includes a bias voltage module. Here, the bias voltage module is configured to provide a dynamic bias voltage; an absolute value of the dynamic bias voltage changes to a first predetermined threshold from the emission start moment according to a first preset rule in a first preset duration and remains a value not smaller than the first predetermined threshold for a second preset duration, and the absolute value of the dynamic bias voltage is smaller than the first predetermined threshold within the first preset duration; where the photoelectric conversion assembly 420 is configured to sequentially convert the first optical signals into the corresponding first electrical signals based on the dynamic bias voltage; and the first preset duration is smaller than a maximal difference between the emission start moment and a receiving moment, and the receiving moment is a moment at which the reflected light is received by the receiving end assembly 400.

If the target object 600 is far away from the light emitting assembly 200, the light intensity of the reflected light received by the light receiving assembly 410 is significantly attenuated compared to the emitted light emitted by the light emitting assembly 200. Since the absolute value of the dynamic bias voltage changes to the first predetermined threshold from the emission start moment in the first preset duration and remains a value not smaller than the first predetermined threshold for the second preset duration, and since it is known from the above that it takes a long time for the emitted light to be reflected back from a distant target object 600, the absolute value of the dynamic bias voltage corresponding to the moment at which the light receiving assembly 410 receives the reflected light is not smaller than the first predetermined threshold, so that the photoelectric conversion units 424 may convert weak optical signals into stronger first electrical signals based on this dynamic bias voltage.

Similarly, if the target object 600 is close to the light emitting assembly 200, the light intensity of the reflected light received by the light receiving assembly 410 is little attenuated compared to the emitted light emitted by the light emitting assembly 200. Since from the emission start moment the absolute value of the dynamic bias voltage is smaller than the first predetermined threshold during the first preset duration, and since it is known from the above that it takes little time for the emitted light to be reflected back from a close target object 600, the absolute value of the dynamic bias voltage corresponding to the moment at which the light receiving assembly 410 receives the reflected light is smaller than the first predetermined threshold, so that the photoelectric conversion units 424 may convert strong optical signals into relatively weaker first electrical signals based on this dynamic bias voltage, to avoid saturation distortion of strong optical signals after amplification by photoelectric conversion.

As can be seen from the above, the radar system in an embodiment of the present disclosure is based on the principle that the intensity of a light beam in a process of propagation decays with the increase of a propagation distance, i.e., the propagation time, and by adopting a time-varying dynamic bias voltage, in the photoelectric conversion process, the reflected light reflected back from the distant target object 600 can correspond to a dynamic bias voltage of a large absolute value, i.e., the absolute value of the dynamic bias voltage is not smaller than the first predetermined threshold, and the reflected light reflected back from the close target object 600 can correspond to a dynamic bias voltage of a reduced absolute value, i.e., the absolute value of the dynamic bias voltage is smaller than the first predetermined threshold. Thus, not only the measurement accuracy in the near distance can be improved and saturation distortion of reflected light beams in the near distance after amplification by photoelectric conversion is avoided, but also a detection ability in the long distance is not affected.

In some embodiments, the absolute value of the dynamic bias voltage changes to a second predetermined threshold from a first adjustment moment according to a second preset rule in a third preset duration and remains a value not smaller than the second predetermined threshold for a fourth preset duration, and the absolute value of the dynamic bias voltage is smaller than the second predetermined threshold within the third preset duration; where the first adjustment moment is earlier than the receiving moment; and the processing apparatus 500 is further configured to determine the adjustment moment based on at least one of the emitting signal, the scanning control signal, the current scanning angle signal, the output signal, or the position where the first electrical signals are output on the photoelectric conversion assembly 420.

As shown in FIG. 12, an embodiment of the present disclosure further provides a laser measurement method, the method including:
S100, generating an emitting signal and sequentially emitting multiple groups of emitted light within a current frame scanning duration according to the emitting signal;
S200, converting at least one group of reflected light formed by reflecting the emitted light at at least one target object 600 in a target scene 700 into an output signal; where a type of the output signal is electrical signal; and
S300, determining at least one of a distance to the target object 600, a reflectivity of the target object 600, or a contour of the target object 600, based on the emitting signal and/or the output signal;
where within the current frame scanning duration, a position of a receiving field of view 102 in the target scene 700 changes according to a first designated rule and/or a shape of the receiving field of view 102 changes according to a second designated rule; from an emission start moment at which corresponding emitted light is emitted, an emitting field of view 101 is located in the current receiving field of view 102 within a preset receiving duration, and an area of the receiving field of view 102 is greater than or equal to twice an area of the emitting field of view 101, where the first designated rule includes a change along a designated direction; the emitting field of view 101 is a projection area of each group of the emitted light in the target scene 700, and the receiving field of view 102 is an area in the target scene 700 corresponding to all light beams that can be converted into the output signal within the preset receiving duration.

Step S200 includes:
S210, sequentially receiving multiple groups of reflected light reflected by the target object 600 and sequentially converting the multiple groups of reflected light into corresponding first optical signals; and
S220, sequentially converting the multiple first optical signals into corresponding first electrical signals.

After performing step S100 and before performing step S200, the laser measurement method further includes:
S110, generating a scanning control signal; and
S120, deflecting the emitted light according to the scanning control signal and irradiating the deflected light to at least one of the target object 600 in the target scene 700, and/or deflecting at least one group of the reflected light reflected by at least one of the target object 600 to a receiving direction.

Further, step S120 includes:
S121, sequentially deflecting the multiple groups of emitted light within the current frame scanning duration along a second scanning direction; and
S122, deflecting along a first scanning direction the emitted light deflected along the second scanning direction, to be irradiated to the target object 600; where the second scanning direction is parallel to a length direction of the receiving field of view 102, the first scanning direction is different from the second scanning direction, and the designated direction is the first scanning direction.

In some embodiments, after performing step S110, the laser measurement method further includes:
generating a current scanning angle signal while deflecting the reflected light reflected by the target object 600; and
determining, based on at least one of the emitting signal, the scanning control signal, the current scanning angle signal, the output signal, or a conversion position of the first electrical signals, an irradiation angle at which the emitted light is irradiated to the target object 600.

Step S100 includes: sequentially emitting at least one group of first emitted light and at least one group of second emitted light within the current frame scanning duration; the emission start moment of the first emitted light being earlier than the emission start moment of the second emitted light; where the second emitted light is visible light; and

Step S200 includes: converting the reflected light formed by reflecting the first emitted light at the corresponding target object 600, into the output signal.

In some embodiments, the deflecting the emitted light according to the scanning control signal, to be irradiated to at least one of the target object 600 in the target scene 700 in step S120, includes: irradiating the first emitted light to the multiple target objects 600 according to the scanning control signal, and projecting the second emitted light onto a surface of one of the multiple target objects 600 according to a preset effect based on at least one of the distance, the irradiation angle, the reflectivity, or the contour. The advantage of such setting is that a preset virtual AR image, i.e., the second emitted light, is projected on the target object 600 to enable users to see enhanced views of the real world and the virtual world.

In some embodiments, the deflecting the emitted light according to the scanning control, to be irradiated to at least one of the target object 600 in the target scene 700 in step S120, includes: irradiating the first emitted light and the second emitted light to two different target objects in the target objects 600 respectively, after deflecting the emitted light according to the scanning control signal. In this case, this step corresponds to an ordinary projection operation.

The above description is only for the embodiments disclosed herein and an explanation of the technical principles used. A person of skill in the art should understand that the scope of protection referred to in this disclosure is not limited to technical solutions formed by specific combinations of the aforementioned technical features, but also includes other technical solutions formed by arbitrary combinations of the aforementioned technical features or their equivalent features without departing from the technical concept. For example, a technical solution is formed by replacing the above features with (but not limited to) technical features with similar functions disclosed in this disclosure.

1. A laser system, comprising:
a light emitting assembly, configured to generate an emitting signal and sequentially emit a plurality of groups of emitted light within a current frame scanning duration according to the emitting signal; wherein the emitting signal comprises time information indicating an emission start moment of each group of the emitted light; and
a receiving end assembly, configured to convert at least one group of reflected light formed by reflecting the emitted light at at least one target object in a target scene into an output signal; wherein a type of the output signal is electrical signal;
wherein within the current frame scanning duration, a position of a receiving field of view of the receiving end assembly in the target scene changes according to a first designated rule and/or a shape of the receiving field of view changes according to a second designated rule; from an emission start moment at which corresponding emitted light is emitted, an emitting field of view of the light emitting assembly is located in the current receiving field of view within a preset receiving duration, and an area of the receiving field of view is greater than or equal to twice an area of the emitting field of view; wherein the first designated rule comprises a change along a designated direction; the emitting field of view is a projection area of each group of the emitted light in the target scene, and the receiving field of view is an area in the target scene corresponding to all light beams that can be received by the receiving end assembly within the preset receiving duration.

2. The laser system according to claim 1, wherein the receiving field of view comprises at least one bar-shaped continuous area, emitting fields of view corresponding to the plurality of groups of emitted light within the current frame scanning duration are arranged in a dot array, and a width direction of the dot array is parallel to the designated direction.

3. The laser system according to claim 2, wherein the continuous area is a curved area.

4. The laser system according to claim 2, wherein a ratio of the area of the emitting field of view to the area of the receiving field of view is smaller than a first ratio threshold, and the first ratio threshold is 0.5, 0.1, 0.01, or 0.001.

5. The laser system according to claim 4, wherein a ratio of a maximal width to a total length of the at least one of continuous area is smaller than the first ratio threshold.

6. The laser system according to claim 2, wherein for two successive groups of the emitted light, from the emission start moment at which a preceding group of the emitted light is emitted until an end of the preset receiving duration after a latter group of the emitted light is emitted, a ratio of a direction angle change magnitude between two adjacent emitting fields of view along a length direction of the dot array to a direction angle change magnitude of the receiving field of view is greater than a second ratio threshold, and the second ratio threshold is 1, 10, 100, 10000 or 1000000.

7. The laser system according to claim 1, wherein a ratio of the area of the emitting field of view to an area of the target scene is smaller than a third ratio threshold, and the third ratio threshold is 0.1, 0.01, 0.001, 0.0001 or 0.0001.

8. The laser system according to claim 1, wherein the emitted light comprises a plurality of light pulses, at least two of the light pulses of the emitted light have an included angle greater than a preset included angle; wherein a ratio of the preset included angle to a field angle of the receiving field of view is smaller than a fourth ratio threshold, and the fourth ratio threshold is 0.01, 0.1, 0.3, 0.5 or 0.9.

9. The laser system according to any one of claims 1 3claim 1, wherein a ratio of an area of the target scene to the area of the receiving field of view is greater than or equal to a fifth ratio threshold, and the fifth ratio threshold is 2, 4, 8, 16, 100, 1000 or 10000.

10. The laser system according to claim 2, wherein the receiving end assembly comprises:
a light receiving assembly, configured to sequentially receive a plurality of groups of reflected light reflected by the target object and sequentially convert the plurality of groups of reflected light into corresponding first optical signals; and
a photoelectric conversion assembly, configured to sequentially convert a plurality of the first optical signals into corresponding first electrical signals.

11. The laser system according to claim 10, wherein the photoelectric conversion assembly comprises:
a photoelectric conversion member, having a continuous photoelectric conversion area; and
an optical element, the optical element having a light inlet end facing the light receiving assembly and a light outlet end facing the photoelectric conversion area; wherein the optical element is configured to selectively transmit the first optical signals to the photoelectric conversion area, and the photoelectric conversion area is configured to convert the first optical signals into the first electrical signals.

12. The laser system according to claim 10, wherein the photoelectric conversion assembly comprises:
a photoelectric unit array, comprising a plurality of photoelectric conversion units disposed sequentially along a preset direction; wherein the photoelectric conversion units are configured to convert the first optical signals into the first electrical signals.

13. The laser system according to claim 12, wherein the photoelectric conversion assembly further comprises:
at least one optical element, disposed between the light receiving assembly and the photoelectric unit array, and configured to deflect a part of the first optical signals, emitted from the light receiving assembly to a direction between two adjacent photoelectric conversion units, to the photoelectric conversion units.

14. The laser system according to claim 12, wherein the photoelectric conversion units comprise at least one of an APD, a SPAD, a SIPM, a PIN or a PD.

15. The laser system according to claim 11, wherein the optical element comprises at least one of a microlens array, at least one diaphragm, a light cone or a light conductor.

16. The laser system according to claim 10, wherein the light receiving assembly comprises at least one lens group, and the lens group comprises at least one receiving lens disposed on an optical path of the reflected light.

17. The laser system according to claim 10, wherein the laser system further comprises:
a scanning control member, configured to generate a scanning control signal;
a light scanning assembly, configured to deflect the emitted light emitted by the light emitting assembly according to the scanning control signal, to be irradiated to at least one of the target object in the target scene, and/or deflect at least one group of the reflected light reflected by at least one of the target object, to be received by the receiving end assembly; and
a processing apparatus, electrically connected to the light emitting assembly, the scanning control member, and the receiving end assembly, respectively, wherein the processing apparatus is, configured to determine at least one of a distance to the target object, a reflectivity of the target object, a directional angle of the target object, or a contour of the target object, based on at least one of the scanning control signal, the emitting signal, and the output signal.

18. The laser system according to claim 17, wherein the light scanning assembly comprises a plurality of light scanning members sequentially disposed along an optical path of the emitted light, wherein one in two adjacent light scanning members of the light scanning members deflects the emitted light to the other light scanning member; wherein the at least two light scanning members have different scanning modes; the scanning modes comprising at least one of an area of a reflective surface of the light scanning member, a scanning direction, a scanning angle range, a scanning frequency or a scanning dimension.

19. The laser system according to claim 18, wherein the plurality of light scanning members comprises a first scanning member and a second scanning member; the first scanning member sequentially deflects a plurality of groups of the emitted light within the current frame scanning duration along a second scanning direction, to be irradiated to the second scanning member; and the second scanning member deflects along a first scanning direction the emitted light deflected by the first scanning member, to be irradiated to the target object;
wherein the second scanning direction is parallel to a length direction of the receiving field of view, the first scanning direction is different from the second scanning direction, and the designated direction is the first scanning direction.

20. The laser system according to claim 19, wherein the first scanning direction and the second scanning direction are a horizontal direction, a vertical direction or an inclined direction; wherein the inclined direction is between the vertical direction and the horizontal direction.

21. The laser system according to claim 19, wherein the first scanning member and the second scanning member comprise at least one of a MEMS mirror, a rotating prism, a rotating wedge, an optical phased array, a photoelectric deflection device, or a liquid crystal scanning member; and the liquid crystal scanning member comprises a liquid crystal spatial light modulator, a liquid crystal superlattice surface, a liquid crystal line array, a transmissive one-dimensional liquid crystal array, a transmissive two-dimensional liquid crystal array, or a liquid crystal display module.

22. The laser system according to claim 17, wherein the light scanning assembly comprises a MEMS mirror and an optical phased array, the optical phased array is fixed to a reflective surface of the MEMS mirror, a light inlet of the optical phased array is connected to the light emitting assembly via a cable, and a light outlet of the optical phased array faces the target object.

23. The laser system according to claim 22, wherein the optical phased array comprises a plurality of waveguides distributed in an array, and a material of the waveguides includes at least one of silicon crystal, silicon oxide, or silicon nitride.

24. The laser system according to claim 17, wherein the light scanning assembly comprises a MEMS mirror and an optical grating array, the optical grating array is fixed to a reflective surface of the MEMS mirror; wherein the emitting signal further comprises wavelength information indicating a wavelength of each group of the emitted light, and a deflection direction of the emitted light is determined based on the wavelength information.

25. The laser system according to claim 17, wherein the light scanning assembly is further configured to generate a current scanning angle signal while deflecting the reflected light reflected by the target object; the processing apparatus is further configured to determine, based on at least one of the emitting signal, the scanning control signal, the current scanning angle signal, the output signal, or a position where the first electrical signals are output on the photoelectric conversion assembly, an irradiation angle at which the emitted light is irradiated to the target object.

26. The laser system according to claim 25, wherein the plurality of groups of the emitted light comprises at least one group of first emitted light and at least one group of second emitted light, the emission start moment of the first emitted light is earlier than the emission start moment of the second emitted light, the reflected light formed by reflecting the first emitted light at the corresponding target object is converted into the output signal, and the second emitted light is visible light;
wherein the light scanning assembly is configured to, after irradiating the first emitted light to a plurality of the target objects, project the second emitted light onto a surface of one of the plurality of the target objects according to a preset effect based on at least one of the distance, the irradiation angle, the reflectivity, or the contour; or
the light scanning assembly is configured to irradiate the first emitted light and the second emitted light to two different target objects in the target objects respectively.

27. The laser system according to claim 26, wherein the second emitted light comprises at least one of red light, blue light, or green light.

28. The laser system according to claim 25, wherein the current scanning angle signal comprises a first scanning angle signal; wherein the first scanning angle signal is a scanning angle signal generated when the light scanning assembly deflects the reflected light along a first scanning direction;
the processing apparatus is configured to determine a component of the irradiation angle along the first scanning direction based on the first scanning angle signal, and determine a component of the irradiation angle along a second scanning direction based on at least one of the scanning control signal, the current scanning angle signal, the output signal, or the position where the first electrical signals are output on the photoelectric conversion assembly; wherein the designated direction is the first scanning direction.

29. The laser system according to claim 25, wherein the laser system further comprises a communication component, the communication component is configured to transmit designated information to outside and/or receive external information; wherein the designated information comprises at least one of the distance to the target object, the reflectivity of the target object, the directional angle of the target object, the contour of the target object, or the irradiation angle.

30. The laser system according to claim 29, wherein the processing apparatus is further configured to determine at least one of a three-dimensional fusion image of the target object, a superpixel of the target object, a superpixel of the receiving field of view, the first designated rule, or the second designated rule, based on a target parameter;
wherein the target parameter comprises at least one of the emitting signal, the scanning control signal, the current scanning angle signal, the output signal, the position where the first electrical signals are output on the photoelectric conversion assembly, or the external information.

31. The laser system according to claim 30, wherein the laser system further comprises an image sensor, and the image sensor is configured to acquire a two-dimensional image of the target scene; the target parameter comprising the two-dimensional image.

32. The laser system according to claim 30, wherein the designated information further comprises the superpixel of the target object.

33. The laser system according to claim 17, wherein the receiving end assembly further comprises electrical amplification modules, and the electrical amplification modules are configured to amplify the first electrical signals into a second electrical signal.

34. The laser system according to claim 33, wherein the photoelectric conversion assembly comprises the photoelectric unit array, a number of the electrical amplification modules is smaller than a number of the photoelectric conversion units in the photoelectric unit array, and output ends of at least two of the photoelectric conversion units are connected to an input end of a given electrical amplification module.

35. The laser system according to claim 33, wherein the photoelectric conversion assembly comprises the photoelectric unit array, a number of the electrical amplification modules is greater than or equal to a number of the photoelectric conversion units in the photoelectric unit array; an output end of each of the photoelectric conversion units is electrically connected to an input end of at least one of the electrical amplification modules, and output ends of at least two of the electrical amplification modules connected to different photoelectric conversion units of the photoelectric conversion units are connected to form a total output end.

36. The laser system according to claim 33, wherein the electrical amplification modules comprise a plurality of amplifiers connected in series or in parallel, at least one of the amplifiers in the plurality of the amplifiers outputs an amplified electrical signal having an intensity smaller than a half of an intensity of an amplified electrical signal output by another amplifier of the amplifiers.

37. The laser system according to claim 36, wherein the processing apparatus comprises:
at least one comparator; wherein an output end of the amplifier outputting at least a maximal amplified electrical signal is connected to an input end of at least one of the comparator, and a comparison input of the comparator corresponds one-to-one with the amplifier; the comparator is configured to compare a voltage value of the comparison input with the electrical signal output by the corresponding amplifier, to determine a trigger start moment, a trigger end moment and a pulse width; wherein the trigger start moment and the trigger end moment are respectively a start moment and an end moment of a period that the intensity of the electrical signal output by the amplifier is higher than the voltage value of the comparison input, and the pulse width is a difference between the trigger end moment and the trigger start moment;
a duration determination module, corresponding one-to-one with the comparator; wherein the duration determination module is configured to determine a light flight duration based on the emission start moment and the trigger start moment output by the corresponding comparator; and
a processor, configured to determine at least one of the distance, the reflectivity or the contour based on at least one of the light flight duration, the pulse width, an intensity of the second electrical signal or speed of light.

38. The laser system according to claim 17, wherein the laser system further comprises:
a main housing, provided with the light emitting assembly, the scanning control member and the processing apparatus; and
at least one probe housing, arranged separately from the main housing; each of the at least one probe housing being provided with the light receiving assembly and the light scanning assembly, the probe housing corresponding one-to-one with the target scene;
wherein the photoelectric conversion assembly is provided in the main housing or the probe housing.

39. The laser system according to claim 38, wherein the light emitting assembly is connected to the light scanning assembly via a first optical fibre, and the processing apparatus is electrically connected to the light emitting assembly, the scanning control member, the photoelectric conversion assembly and the light scanning assembly respectively, via a cable.

40. The laser system according to claim 17, wherein the laser system further comprises:
a display component, configured to display at least one of the distance, the reflectivity or the contour; and/or
a prompting component, configured to output a prompting signal based on at least one of the distance, the reflectivity or the contour.

41. The laser system according to claim 25, wherein the receiving end assembly further comprises:
a bias voltage module, configured to provide a dynamic bias voltage; an absolute value of the dynamic bias voltage changing to a first predetermined threshold from the emission start moment according to a first preset rule in a first preset duration and remaining a value not smaller than the first predetermined threshold for a second preset duration, and the absolute value of the dynamic bias voltage being smaller than the first predetermined threshold within the first preset duration;
wherein the photoelectric conversion assembly is configured to sequentially convert the first optical signals into the corresponding first electrical signals based on the dynamic bias voltage; and the first preset duration is smaller than a maximal difference between the emission start moment and a receiving moment, and the receiving moment is a moment at which the reflected light is received by the receiving end assembly.

42. The laser system according to claim 41, wherein the absolute value of the dynamic bias voltage changes to a second predetermined threshold from a first adjustment moment according to a second preset rule in a third preset duration and remains a value not smaller than the second predetermined threshold for a fourth preset duration, and the absolute value of the dynamic bias voltage is smaller than the second predetermined threshold within the third preset duration; wherein the first adjustment moment is earlier than the receiving moment;
the processing apparatus is further configured to determine the adjustment moment based on at least one of the emitting signal, the scanning control signal, the current scanning angle signal, the output signal, or the position where the first electrical signals are output on the photoelectric conversion assembly.

43. A laser measurement method, comprising:
generating an emitting signal and sequentially emitting a plurality of groups of emitted light within a current frame scanning duration according to the emitting signal;
converting at least one group of reflected light formed by reflecting the emitted light at at least one target object in a target scene into an output signal; wherein a type of the output signal is electrical signal; and
determining at least one of a distance to the target object, a reflectivity of the target object, or a contour of the target object, based on the emitting signal and/or the output signal;
wherein within the current frame scanning duration, a position of a receiving field of view in the target scene changes according to a first designated rule and/or a shape of the receiving field of view changes according to a second designated rule; from an emission start moment at which corresponding emitted light is emitted, an emitting field of view is located in the current receiving field of view within a preset receiving duration, and an area of the receiving field of view is greater than or equal to twice an area of the emitting field of view;
wherein the first designated rule comprises a change along a designated direction; the emitting field of view is a projection area of each group of the emitted light in the target scene, and the receiving field of view is an area in the target scene corresponding to all light beams that can be converted into the output signal within the preset receiving duration.

44. The laser measurement method according to claim 43, wherein the converting at least one group of reflected light formed by reflecting the emitted light at at least one target object in a target scene into an output signal, comprises:
sequentially receiving a plurality of groups of reflected light reflected by the target object and sequentially converting the plurality of groups of reflected light into corresponding first optical signals; and
sequentially converting a plurality of the first optical signals into corresponding first electrical signals.

45. The laser measurement method according to claim 44, wherein before performing the step of converting at least one group of reflected light formed by reflecting the emitted light at at least one target object in a target scene into an output signal, the laser measurement method further comprises:
generating a scanning control signal; and
deflecting the emitted light according to the scanning control signal, to be irradiated to at least one of the target object in the target scene, and/or deflecting at least one group of the reflected light reflected by at least one of the target object to a receiving direction.

46. The laser measurement method according to claim 45, wherein the deflecting the emitted light according to the scanning control signal, to be irradiated to at least one of the target object in the target scene, comprises:
sequentially deflecting the plurality of groups of emitted light within the current frame scanning duration along a second scanning direction; and
deflecting, along a first scanning direction, the emitted light deflected along the second scanning direction, to be irradiated to the target object;
wherein the second scanning direction is parallel to a length direction of the receiving field of view, the first scanning direction is different from the second scanning direction, and the designated direction is the first scanning direction.

47. The laser measurement method according to claim 45, wherein after performing the step of generating a scanning control signal, the laser measurement method further comprises:
generating a current scanning angle signal while deflecting the reflected light reflected by the target object; and
determining, based on at least one of the emitting signal, the scanning control signal, the current scanning angle signal, the output signal, or a conversion position of the first electrical signals, an irradiation angle at which the emitted light is irradiated to the target object.

48. The laser measurement method according to claim 47, wherein the step of generating an emitting signal and sequentially emitting a plurality of groups of emitted light within a current frame scanning duration according to the emitting signal, comprises:
sequentially emitting at least one group of first emitted light and at least one group of second emitted light within the current frame scanning duration; the emission start moment of the first emitted light being earlier than the emission start moment of the second emitted light, and the second emitted light being visible light;
wherein the step of converting at least one group of reflected light formed by reflecting the emitted light at at least one target object in a target scene into an output signal, comprises:
converting the reflected light formed by reflecting the first emitted light at the corresponding target object into the output signal.

49. The laser measurement method according to claim 48, wherein the step of deflecting the emitted light according to the scanning control signal, to be irradiated to the at least one target object in the target scene, comprises:
irradiating the first emitted light to a plurality of the target objects according to the scanning control signal; and
projecting the second emitted light onto a surface of one of the plurality of the target objects according to a preset effect based on at least one of the distance, the irradiation angle, the reflectivity, or the contour.

50. The laser measurement method according to claim 48, wherein the step of deflecting the emitted light according to the scanning control signal, to be irradiated to at least one of the target object in the target scene, comprises:
irradiating the first emitted light and the second emitted light to two different target objects in the target objects respectively, after deflecting the emitted light according to the scanning control signal.
